(19) United States
(12) Patent Application Publication
(10) Pub. No.: US 2025/0138580 A1
(43) Pub. Date: May 1, 2025

(54) FUNCTIONAL ASSEMBLY AND ELECTRONIC DEVICE

(71) Applicant: Lenovo (Beijing) Limited, Beijing (CN)

(72) Inventors: Benxin LIAO, Beijing (CN); Detao YOU, Beijing (CN)

(21) Appl. No.: 18/932,536

(22) Filed: Oct. 30, 2024

(30) Foreign Application Priority Data
Oct. 31, 2023 (CN) 202311434518.1

(51) Int. Cl. G06F 1/16

(52) U.S. Cl. CPC G06F 1/1618; G06F 1/1641; G06F 1/1662; G06F 1/1647

(57) ABSTRACT

A functional assembly includes a main body, a first functional member, a second functional member, and a connection member. The first functional member is movably connected to the main body. The second functional member moves relative to the first functional member along a first direction and is movably connected to the main body. The connection member is connected to the first functional member and the second functional member to cause the second functional member to switch between a first state and a second state relative to the first functional member.

### CROSS REFERENCE TO RELATED APPLICATION

The present disclosure claims priority to Chinese Patent Application No. 202311434518.1, filed on Oct. 31, 2023, the entire content of which is incorporated herein by reference.

### TECHNICAL FIELD

The present disclosure is related to the electronic device technology field and, more particularly, to a functional assembly and an electronic device.

### BACKGROUND

As electronic devices become widely used, they are used in various manners and various user scenarios.

Currently, in different scenarios, users have different requirements on how electronic devices are positioned. Thus, to facilitate applications of the users, the electronic devices need to have different application forms.

### SUMMARY

An aspect of the present disclosure provides a functional assembly including a main body, a first functional member, a second functional member, and a connection member. The first functional member is movably connected to the main body. The second functional member moves relative to the first functional member along a first direction and is movably connected to the main body. The connection member is connected to the first functional member and the second functional member to cause the second functional member to switch between a first state and a second state relative to the first functional member.

An aspect of the present disclosure provides an electronic device including a first body and a functional assembly. The functional assembly includes a main body, a first functional member, a second functional member, and a connection member. The first functional member is movably connected to the main body. The second functional member moves relative to the first functional member along a first direction and is movably connected to the main body. The connection member is connected to the first functional member and the second functional member to cause the second functional member to switch between a first state and a second state relative to the first functional member.

### BRIEF DESCRIPTION OF THE DRAWINGS

FIG. 1 illustrates a schematic side-view structural diagram showing a first state of an electronic device according to some embodiments of the present disclosure.

FIG. 2 illustrates a schematic front-view structural diagram showing a first state of an electronic device according to some embodiments of the present disclosure.

FIG. 3 illustrates a schematic side-view structural diagram showing an electronic device being switched between a first state and a second state according to some embodiments of the present disclosure.

FIG. 4 illustrates a schematic front-view structural diagram showing an electronic device being switched between a first state and a second state according to some embodiments of the present disclosure.

FIG. 5 illustrates a schematic side-view structural diagram showing a second state of an electronic device according to some embodiments of the present disclosure.

FIG. 6 illustrates a schematic front-view structural diagram showing a first state of an electronic device according to some embodiments of the present disclosure.

FIG. 7 illustrates a schematic side-view process diagram showing a first body being switched between a first state and a second state according to some embodiments of the present disclosure.

FIG. 8 illustrates a schematic structural diagram of a functional assembly according to some embodiments of the present disclosure.

FIG. 9 illustrates a schematic exploded diagram of a functional assembly according to some embodiments of the present disclosure.

FIG. 10 illustrates a schematic first locally enlarged diagram showing a first state of a functional assembly according to some embodiments of the present disclosure.

FIG. 11 illustrates a schematic locally enlarged diagram showing a second state of a functional assembly according to some embodiments of the present disclosure.

FIG. 12 illustrates a schematic process diagram showing a first functional member and a second functional member being switched between a first state and a second state according to some embodiments of the present disclosure.

FIG. 13 illustrates a schematic process diagram showing a connection member being switched between a first state and a second state according to some embodiments of the present disclosure.

FIG. 14 illustrates a schematic process diagram showing a first body being switched between a first state and a second state according to some embodiments of the present disclosure.

FIG. 15 illustrates a schematic second local enlarged diagram showing a first state of a functional assembly according to some embodiments of the present disclosure.

FIG. 16 illustrates a schematic structural diagram of a lock structure according to some embodiments of the present disclosure.

### DETAILED DESCRIPTION OF THE EMBODIMENTS

The present disclosure provides a functional assembly to adapt to different application forms of an electronic device. The present disclosure further provides the electronic device.

The technical solutions of embodiments of the present disclosure are described in detail in connection with the accompanying drawings of embodiments of the present disclosure. Apparently, the described embodiments are only some embodiments of the present disclosure, not all embodiments. Based on embodiments of the present disclosure, all other embodiments obtained by those of ordinary skills in the art should be within the scope of the present disclosure.

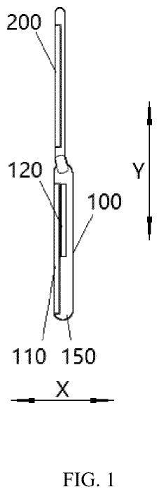

As shown in FIG. 1 to FIG. 9, embodiments of the present disclosure provide a functional assembly. The functional assembly includes a main body 130, a first functional member 110, a second functional member 120, and a connection member 140.

The first functional member 110 is movably connected to the main body 130. The second functional member 120 can move relative to the first functional member 110 along first direction X and is movably connected to the main body 130. The connection member 140 is connected to the first functional member 110 and the second functional member 120 to allow the second functional member 120 to switch between a first state and a second state relative to the first functional member 110.

In the functional assembly of embodiments of the present disclosure, the first functional member 110 and the second functional member 120 can be movably connected to the main body 130. Furthermore, the connection member 140 can connect the first functional member 110 and the second functional member 120 to allow the first functional member 110 to drive the second functional member 120 to move relative to the main body 130 when moving relative to the main body 130, and allow the second functional member 120 to move along first direction X relative to the first functional member 110 to realize switching of the second functional member 120 between the first state and the second state relative to the first functional member 110. With the above functional assembly, the relative position between the first functional member 110 and the second functional member 120 can at least include the first state and the second state to adapt to the different application forms of the electronic device.

In embodiments of the present disclosure, the first functional member 110 can be a display assembly, i.e., a first display surface configured to output information. The first display surface can be used as a first functional surface of the first functional member 110.

The first functional member 110 can be a touchscreen. That is, the first functional surface can be used as a touch-sensitive surface.

Further, the first functional member 110 can include a first functional element 118 and a first functional element bracket 119. The first functional element 118 can be a screen. The first functional element 118 can be arranged at the first functional element bracket 119. The first functional element bracket 119 can cooperate with other members, such as the main body 130 or connection member 140. The first functional element 118 can be a non-flexible screen. That is, the first functional element 118 can be laid flat at the first functional element bracket 119. In some other embodiments, the first functional element 118 can be a flexible screen. The first functional element 118 can be arranged at the first functional element bracket 119 with a certain curvature. The first functional element 118 can be a flexible folding screen. The first functional element bracket 119 can at least include a first frame member and a second frame member that can be folded or unfolded relatively. A part of the first functional element 118 can be connected to the first frame member. Another part of the first functional element 118 can be connected to the second frame member. The first functional element 118 (the flexible folding screen) can be relatively folded and unfolded through the relative folding and unfolding of the first frame member and the second frame member.

In embodiments of the present disclosure, the second functional member 120 can be an input assembly. The second functional member 120 can be a keyboard, such as a mechanical keyboard or a non-mechanical keyboard (e.g., a membrane keyboard). The surface of the keyboard with keys can be a second functional surface of the second functional member 120.

In some embodiments, the second functional member 120 can include a second functional element 128 and a second functional element bracket 129. The second functional element 128 can be a keyboard arranged at the second functional element bracket 129. The second functional element bracket 129 can cooperate with other members, such as the main body 130 or connection member 140.

The second functional member 120 can also be a display assembly, i.e., a second display surface configured to output information. The second display surface can be a second functional surface of the second functional member 120.

The second functional element 128 can be a screen arranged at the second functional element bracket 129. The second functional element bracket 129 can cooperate with other members, such as the main body 130 or connection member 140. Similarly, the second functional element 128 (the screen) can be a non-flexible screen, a flexible screen, or a flexible folding screen.

In the first state, the first functional member 110 can cover the second functional surface of the second functional member 120 to allow the user to only perform corresponding operations on the first functional member 110. In the second state, the first functional surface of the first functional member 110 and the second functional surface of the second functional member 120 can be exposed to the outside. In some embodiments, the first functional member 110 and the second functional member 120 can be display assemblies. The first display surface and the second display surface can be spliced for use, or the first display surface and the second display surface can be used independently.

Of course, the first functional member 110 can also be an input assembly.

In some embodiments, the first functional member 110 and the second functional member 120 can be input assemblies. The first functional member 110 and the second functional member 120 can have different input methods or different input types. For example, the first functional member 110 and the second functional member 120 can be keyboards. The keys of the first functional member 110 can be frequently used keys, and the keys of the second functional member 120 can be less frequently used keys. In the first state, the first functional member 110 can cover the second functional surface of the second functional member 120 to allow the user to only perform the corresponding operations on the frequently used keys. In the second state, the first functional surface of the first functional member 110 and the second functional surface of the second functional member 120 can be exposed to the outside. The user can perform the corresponding operations on the frequently used keys and the less frequently used keys. The frequently used keys and the less frequently used keys can be determined according to the user's needs, which are not limited here.

The main body 130 can be a bracket structure.

For example, in some embodiments, the electronic device can be a tablet. The tablet can include a housing structure. The main body 130 can be the bracket structure arranged in the housing structure.

In some other embodiments, the electronic device can be a laptop. The laptop can include a screen member and a system member. The main body 130 can be the bracket structure arranged in the housing of the system member.

With the connection member 140, the first functional member 110, the second functional member 120, and the main body 130 can form a linkage structure. That is, in the first state and the second state, the first functional member 110 and the second functional member 120 can have different relative positions. In the first state and the second state, the first functional member 110 and the main body 130 can have different relative positions. In the first state and the second state, the second functional member 120 and the main body 130 can have different relative positions.

Furthermore, the first functional member 110 can be movably connected to the main body 130 along second direction Y. First direction X and second direction Y can have an angle. In some embodiments, the first functional member 110 can move relative to the main body 130 along second direction Y, while the second functional member 120 can move relative to the first functional member 110 along first direction X. Therefore, the second functional member 120 can move relative to the main body 130 along first direction X and second direction Y.

In some embodiments, first direction X can be perpendicular to second direction Y.

Of course, the first functional member 110 can also be movably connected to the main body 130 along first direction X. That is, the first functional member 110 can approach and move away from the second functional member 120 relatively. Thus, the second functional member can move along first direction X relative to the first functional member. In connection with the movement of the second functional member relative to the main body 130 (e.g., along second direction Y), the second functional member can also be switched between the first state and the second state relative to the first functional member.

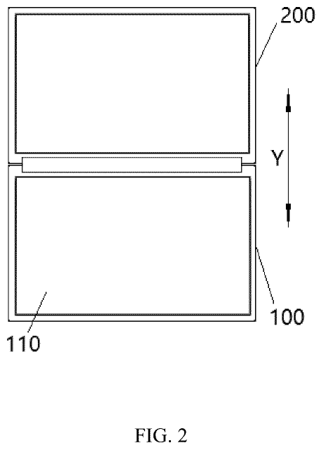

As shown in FIG. 1 and FIG. 2, in the first state, the first functional member 110 and the second functional member 120 are arranged along first direction X. An orthogonal projection of the first functional member 110 along first direction X can at least partially cover the second functional member 120. When the first functional member 110 and the second functional member 120 have plate-shaped structures, the first functional member 110 and the second functional member 120 can be stacked on top of each other. A gap can be provided between the first functional member 110 and the second functional member 120. Thus, during the switching between the first state and the second state, the first functional member 110 and the second functional member 120 may not have friction with each other. Thus, the user can operate the first functional member 110. Moreover, with the relative position between the first functional member 110 and the second functional member 120, the overall size of the first functional member 110 and the second functional member 120 along second direction Y can be relatively small to satisfy a corresponding function, e.g., easy to carry or place.

In some embodiments, the orthogonal projection of the first functional member 110 along first direction X can completely cover the second functional member 120. That is, the area of the orthogonal projection of the first functional member 110 along first direction X can be larger than the area of the orthogonal projection of the second functional member 120 along first direction X. Moreover, in the first state, the first functional member 110 can completely cover the second functional member 120.

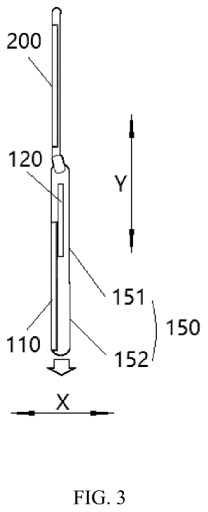

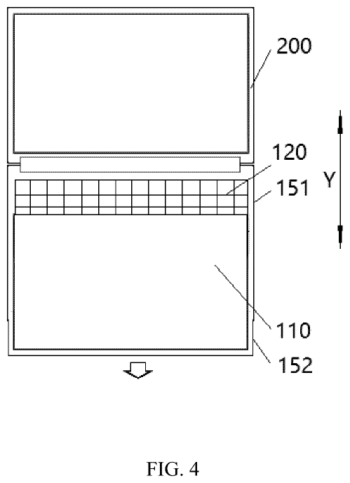

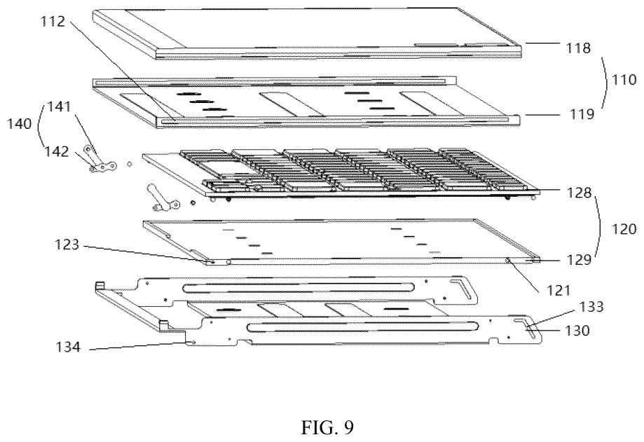

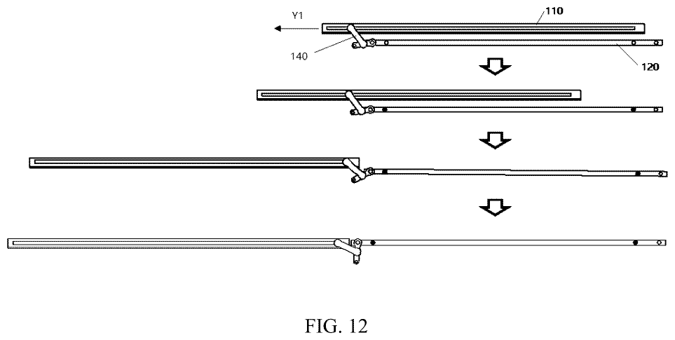

As shown in FIG. 3, FIG. 4, FIG. 8, FIG. 9, and FIG. 12, when switching from the first state to the second state, the first functional member 110 moves relative to the main body 130 (inside the housing 150) along second direction Y. Thus, the total size of the first functional member 110 and the second functional member 120 increases.

In embodiments of the present disclosure, the first functional member 110 can move relative to the main body 130 (the direction of the hollow arrows in FIG. 3 and direction Y1 in FIG. 12) to drive the second functional member 120 to move relative to the main body 130.

Of course, the user can also only move the second functional member 120. That is, the second functional member 120 can move relative to the main body 130 in a direction along second direction Y (an upward direction in FIG. 3). Moreover, the second functional member 120 can be driven by the connection member 140 to move relative to the first functional member 110 along a side of first direction X (e.g., a direction to the left in FIG. 3) to be switched from the first state to the second state.

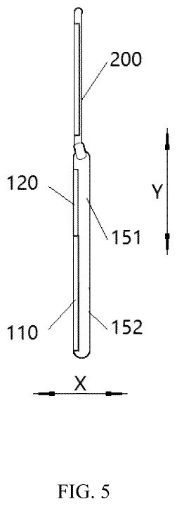

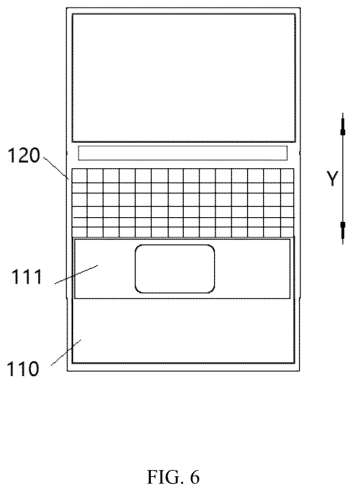

As shown in FIG. 5 and FIG. 6, in the second state, the first functional member 110 and the second functional member 120 are arranged along second direction Y. The orthogonal projection of the first functional member 110 along second direction Y can at least partially cover the second functional member 120. In the second state, the operation of the user on the first functional member 110 and the second functional member 120 can be satisfied. When the first functional member 110 and the second functional member 120 are independent functional members, the first functional member 110 and the second functional member 120 can be operated independently. The first functional member 110 and the second functional member 120 can also be interactively operated through the connection structure (electrical connection or mechanical connection).

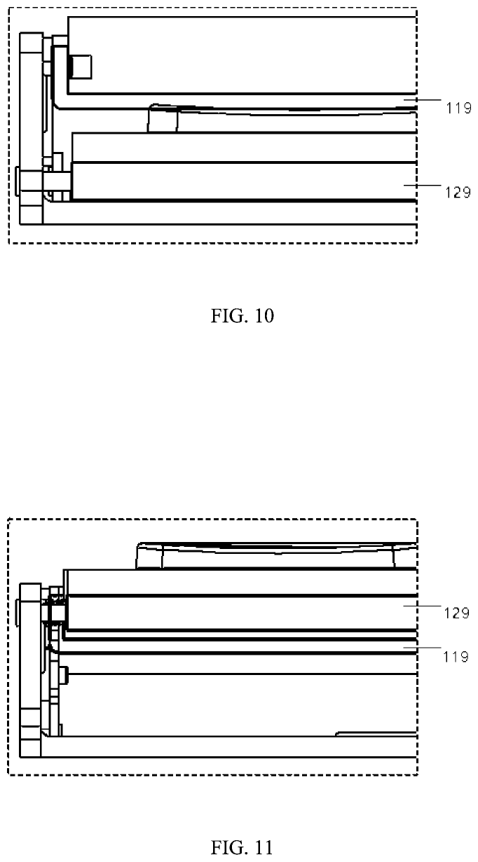

As shown in FIG. 9, FIG. 10, and FIG. 11, the first functional member 110 includes the first functional element 118 and the first functional element bracket 119. The second functional member 120 includes a second functional element 128 and a second functional element bracket 129. As shown in FIG. 10, in the first state, a gap exists between the first functional element bracket 119 and the second functional element bracket 129, and the second functional element bracket 129 is located below the first functional element bracket 119. As shown in FIG. 11, in the second state, the first functional element bracket 119 and the second functional element bracket 129 partially overlap with each other in the direction shown in the figure. The second functional element bracket 129 can be above the first functional element bracket 119.

In some embodiments, the second functional member 120 can move along first direction X to splice the first functional member 110 and the second functional member 120 along second direction Y. Thus, the first functional member 110 and the second functional member 120 can be operated together.

Furthermore, in the second state, the first functional member 110 can be aligned with at least one surface of the second functional member 120 facing first direction X. Of course, the first functional member 110 and the second functional member 120 can have a distance difference along first direction X.

In embodiments of the present disclosure, the first functional member 110 can include the first functional surface. The second functional member 120 can include the second functional surface.

In embodiments of the present disclosure, when the second functional member 120 switches between the first state and the second state relative to the first functional member 110, the first functional surface and the second functional surface can face the same direction. In some embodiments, the same direction faced by the first functional surface and the second functional surface can be on one side of the first direction X, i.e., the direction facing to the left in FIG. 1, FIG. 3, and FIG. 5.

In the first state and the second state, the first functional surface and the second functional surface can also face the same direction. Moreover, when switching between the first state and the second state, the first functional surface and the second functional surface can always face the same direction.

In some embodiments, in the second state, the first functional surface and the second functional surface can be coplanar.

Thus, the user can perform the corresponding operations on the first functional member 110 and the second functional member 120 from the same side.

In some embodiments, the size of the first functional surface can be larger than the size of the second functional surface. With the above configuration, the second functional surface can be completely covered by the first functional surface in the first state to avoid mistouch of the second functional surface in the first state.

As shown in FIG. 8 and FIG. 9, the main body 130 includes accommodation space. In the first state, the first functional member 110 is at least partially arranged within the accommodation space, and the second functional member 120 can be arranged within the accommodation space. The compactness of the structure can be improved through the above configuration.

Of course, the main body 130, the first functional member 110, and the second functional member 120 can also be stacked.

Furthermore, in the first state, the first functional member 110 can be arranged within the accommodation space, and the second functional member 120 can be at least partially arranged within the accommodation space.

In the functional assembly of embodiments of the present disclosure, the first functional member 110 can include a first sliding cooperation structure 112 sliding-cooperating with the connection member 140. The second functional member 120 can include a first rotation cooperation structure 123 rotation-cooperating with the connection member 140.

The connection member 140 can include a first linkage rod 141 and a second linkage rod 142.

The first end of the first linkage rod 141 can slidingly cooperate with the first sliding cooperation structure 112 to allow the first functional member 110 to move along second direction Y.

The second linkage rod 142 can be rotatably connected to the first linkage rod 141. One end of the second linkage rod 142 can be rotatably connected to the first rotation cooperation structure 123. The other end of the second linkage rod 142 can be rotatably connected to the main body 130.

In some embodiments, the first sliding cooperation structure 112 and the first end of the first linkage rod 141 can form a sliding-rotation cooperation structure. That is, the first end of the first linkage rod 141 can slidingly cooperate with the first sliding cooperation structure 112, and the first linkage rod 141 and the first sliding cooperation structure 112 (the first functional member 110) can rotate relatively.

In some embodiments, the first sliding cooperation structure 112 can be a sliding groove structure, and the first end of the first linkage rod 141 can be a sliding block. The sliding block can slide along the extension direction of the sliding groove structure. In some embodiments, the sliding block can have a cylindrical structure to allow the sliding block to rotate in the sliding groove structure.

Of course, the first sliding cooperation structure 112 can be configured as a sliding rail (a protrusion). The first sliding cooperation structure 112 can be a connection shaft rotatably having a first sliding-rotation connection. The end surface of the connection shaft can slide cooperating with the sliding rail.

Furthermore, the other end of the second linkage rod 142 can be rotatably connected to the fixing position of the main body 130. For example, the main body can include a main body connection member 134. The other end of the second linkage rod 142 can be rotatably connected to the main body connection member 134.

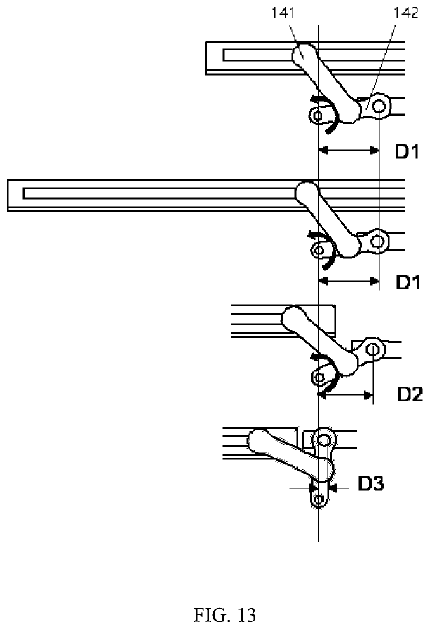

As shown in FIG. 9, FIG. 12, and FIG. 13, the first functional member 110 includes a first side and a second side opposite the first side. The first side and the second side of the first functional member 110 are arranged along direction Y1.

When switching from the first state to the second state, one end of the second linkage rod 142 can slide from the first side of the first functional member 110 to the second side of the first functional member 110.

In the first stage (including the first state), the first linkage rod 141 may not rotate, a dimension of an end of the second linkage rod 142 to the other end of the second linkage rod 142 can be D1.

In the second stage, after one end of the first linkage rod 141 abuts against a side wall (end wall of the sliding groove) of the sliding cooperation structure located on the second side, when the first functional member 110 further moves in direction Y1 on a side of second direction Y, the first linkage rod 141 can drive the second linkage rod 142 to rotate relative to the main body 130 (in the direction shown by the arrow in FIG. 13). Thus, the dimension from the one end of the second linkage rod 142 to the other end of the second linkage rod 142 can be reduced to D2 along the horizontal direction.

In the third stage (including the second state), the second functional member 120 can be switched to the second state relative to the first functional member 110 to reduce the dimension from one end of the second linkage rod 142 to the other end of the second linkage rod 142 in the horizontal direction (second direction Y) to D3.

Among these, D1>D2>D3.

Of course, the connection member 140 can also have other structures, such as a gear-rack transmission, a worm gear-worm transmission, or a gear assembly meshing transmission.

In some embodiments, an external force can be applied to the first functional member 110 to cause the first functional member 110 to move along second direction Y to switch between the first state and second state. In some other embodiments, an external force can be applied to the second functional member 120 to switch between the first state and the second state.

A drive apparatus can be provided to apply a drive force to the first functional member 110, the connection member 140, or the second functional member 120 to switch between the first state and the second state.

To improve the movement stability of the second functional member 120, the second functional member 120 can include a first guiding structure 121, and the main body 130 can include a second guiding structure 133 matching the first guiding structure 121.

The second guiding structure 133 can be arranged on a side of the main body 130 away from the connection member 140.

As shown in FIG. 8, the second guiding structure 133 is a sliding groove structure, and the first guiding structure 121 is a protrusion that slides along the sliding groove.

Furthermore, the sliding groove structure can include a first groove section and a second groove section. The first groove section can be inclined along the direction close to the first functional member towards the direction close to the connection member 140. The second groove section can communicate with one end of the first groove section close to the first functional member and can be arranged along second direction Y.

In the first state, the first guiding structure 121 can be arranged at an end of the first groove section away from the second groove section.

In the second state, the first guiding structure 121 can be arranged at the second groove section. Since the second groove section is arranged along second direction Y, a positioning function can be provided to the second functional member 120.

The sliding groove structure can be configured as a Z-shaped groove. That is, a third groove section can be added at an end of the first groove section away from the second groove section along second direction Y. Moreover, along second direction Y, the second groove section and the third groove section can be arranged on two sides of the first groove section, respectively. With the third groove section, the positioning function can be provided to the second functional member 120 in the first state.

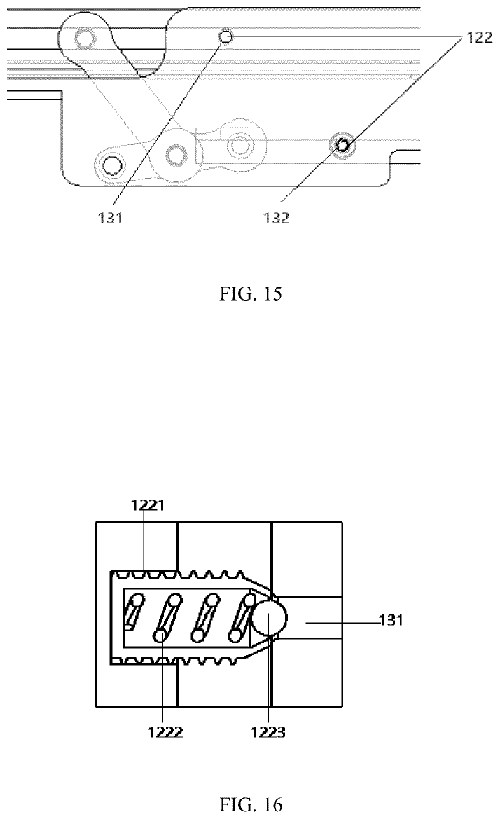

As shown in FIG. 1, FIG. 8, and FIG. 15, the second functional member 120 further includes a locking structure 122. The main body 130 includes a first positioning structure 131 and a second positioning structure 132, which cooperates with the locking structure 122. The first positioning structure 131 and the second positioning structure 132 have positions along first direction X.

In the first state, the locking structure 122 can cooperate with the first positioning structure 131 for positioning.

In the second state, the locking structure 122 can cooperate with the second positioning structure 132 for positioning.

With the above configuration, the movement of the second functional member 120 relative to the main body 130 can be restricted.

The movement of the second functional member 120 relative to the main body 130 can be achieved by applying the external force or by additionally providing a drive apparatus to drive the second functional member 120 to move along first direction X. That is, the drive device can provide the force for the switching of the first functional member 110 and the second functional member 120 between the first state and the second state.

In some embodiments, two first positioning structures 131 and two second positioning structures 132 can be provided and can be arranged along second direction Y at the main body 130.

As shown in FIG. 16, for example, the locking structure 122 cooperates with the first positioning structure 131 for positioning. The first positioning structure 131 is a through-hole. The locking structure 122 includes a mounting base 1221, a compression spring 1222, and a positioning ball 1223. Two ends of the compression spring 1222 abut against the mounting base 1221 and the positioning ball 1223, respectively. The mounting base 1221 can restrict the positioning ball 1223 to move along the axial direction of the mounting base 1221. The positioning ball 1223 can be partially exposed to the outside and rotatably arranged at the mounting base 1221. When the locking structure 122 cooperates with the first positioning structure 131 for positioning, the positioning ball 1223 can be partially sapped in the first positioning structure 131.

Of course, the first positioning structure 131 and the second positioning structure 132 can also be configured as slots or hooks, as long as the locking structure 122 can cooperate with the first positioning structure 131 and the second positioning structure 132 in the corresponding states.

The present disclosure also provides an electronic device including a functional assembly and a first body 100.

The functional assembly can be any one of the functional assembly. The main body 130 of the functional assembly is arranged in the housing 150 of the first body 100.

Since the functional assembly includes the above technical effects, and the electronic device of the present disclosure includes the above functional assembly, the electronic device can have the same technical effects as the functional assembly, which is described in detail here.

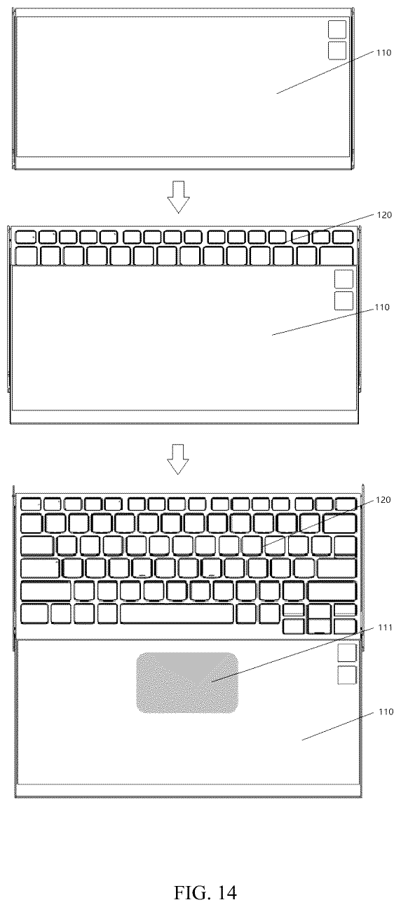

As shown in FIGS. 1 to 7 and FIG. 14, to improve the protection for the functional assembly, the housing 150 includes a first housing 151 and a second housing 152 that move relative to each other. The first housing 151 and the second housing 152 form a chamber structure to accommodate the functional assembly.

The first functional member 110 and the first housing 151 of the functional assembly can move synchronously. The main body 130 can be arranged in the second housing 152.

The first housing 151 and the second housing 152 can be connected by members such as retractable tubes, or the first housing 151 and the second housing 152 can be sleeved with each other. For example, one end of the first housing 151 facing the second housing 152 can be arranged on an outer side of one end of the second housing 152 close to the first housing 151. Through the switching of the functional assembly between the first state and the second state, the total lengths of the first housing 151 and the second housing 152 can change in second direction Y.

Further, in embodiments of the present disclosure, the first functional member 110 can be a touchscreen, and the second functional member 120 can be a mechanical keyboard. To further improve the application effect, in the second state, the functional surface of the first functional member 110 can include a virtual touchpad area 111, which can be applied in cooperation with the second functional member.

Further, the electronic device of the present disclosure further includes a second body 200. When the first body 100 and the second body 200 are in the first attitude, the first body 100 and the second body 200 can be folded relatively. When the first body 100 and the second body 200 are in the second attitude, the first body 100 and the second body 200 can be unfolded relatively.

As shown in FIGS. 1 to 6, in some embodiments, the first body 100 includes a first display assembly, and the second body 200 includes a second display assembly. That is, the first body 100 and the second body 200 can be applied for display. The display content of the first body 100 can be the same as or different from the display content of the second body 200. When the display content of the first display assembly is different from the display content of the second display assembly, the display surface of the first display assembly can be spliced with the display surface of the second display assembly for use, or the display surface of the first display assembly can be used as a sub-screen of the display surface of the second display assembly. Further, one of the first display assembly and the second display assembly can be used as a display screen, and the other one of the first display assembly and the second display assembly can be used as a virtual keyboard of the electronic device. The display assembly used as the input device such as the virtual keyboard can be a touch screen. The display assembly used as the display screen can be also a touch screen or a non-touch screen.

That is, the first display assembly and the second display assembly can display independently or can be used interactively to realize a plurality of forms of application modes.

In some embodiments, the first display assembly and the second display assembly can have the same dimension. By enlarging the dimensions of the first display assembly and the second display assembly, the display area can be effectively enlarged. Of course, the first display assembly and the second display assembly can have different dimensions.

The first display assembly (the first functional member 110) can slide along the direction away from the second display assembly or along the directions on two sides of the second display assembly.

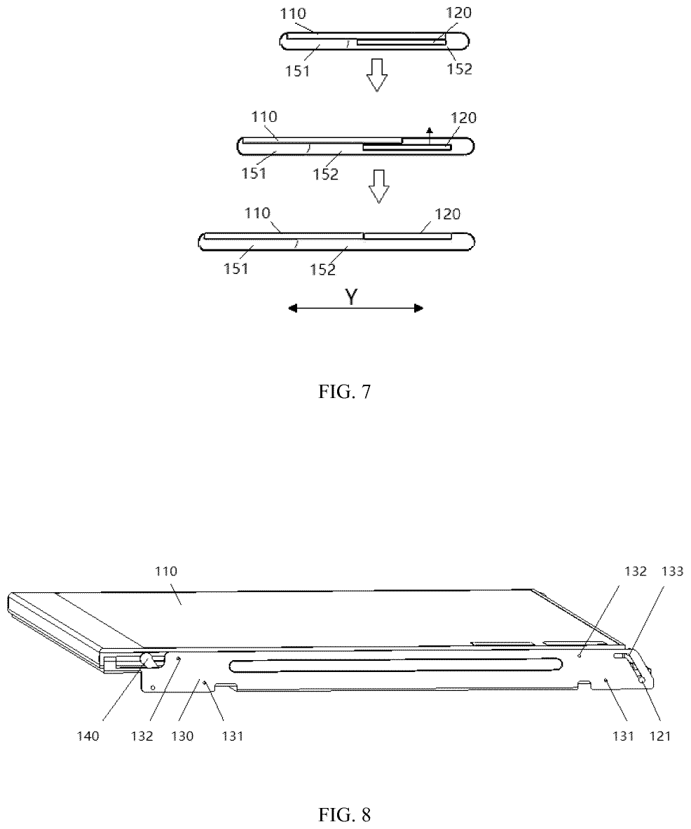

When the first display assembly slides, the second functional member 120 (the keyboard) can be exposed to the outside and lifted (the direction of the single arrow in FIG. 7) driven by the connection member 140. Thus, the second functional member 120 can be flush with the first display assembly (the first functional member 110) to facilitate performing corresponding operations on the second functional member 120.

Of course, the electronic device can only include the first body 100.

Embodiments of the present disclosure are described progressively. Each embodiment focuses on the differences from other embodiments. For parts that are similar or the same between embodiments, reference can be made to one another.

The above description of embodiments of the present disclosure can enable those skilled in the art to implement or use the present disclosure. Various modifications to embodiments of the present disclosure can be obvious to those skilled in the art. The general principles defined here can be realized in other embodiments without departing from the spirit or scope of the present disclosure. Therefore, the present disclosure is not limited to embodiments of the present disclosure but conforms to the broadest scope consistent with the principle and novel features of embodiments of the present disclosure.

What is claimed is:

1. A functional assembly comprising:
a main body;
a first functional member movably connected to the main body;
a second functional member moving relative to the first functional member along a first direction and movably connected to the main body; and
a connection member connected to the first functional member and the second functional member to cause the second functional member to switch between a first state and a second state relative to the first functional member.

2. The functional assembly according to claim 1, wherein:
the first functional member is movably connected to the main body along a second direction; and
the first direction and the second direction form an angle.

3. The functional assembly according to claim 2, wherein:
in the first state, the first functional member and the second functional member are arranged along the first direction, and an orthogonal projection of the first functional member along the first direction at least partially covers the second functional member; and
in the second state, the first functional member and the second functional member are arranged along the second direction, and an orthogonal projection of the first functional member along the second direction at least partially covers the second functional member.

4. The functional assembly according to claim 1, wherein:
the first functional member includes a first functional surface, and the second functional member includes a second functional surface; and
when the second functional member switches between the first state and the second state relative to the first functional member, the first functional surface and the second functional surface face a same direction.

5. The functional assembly according to claim 1, wherein:
the main body includes an accommodation space; and
in the first state, at least a part of the first functional member is in the accommodation space, and the second functional member is in the accommodation space.

6. The functional assembly according to claim 2, wherein:
the first functional member includes a first sliding cooperation structure that sliding-cooperates with the connection member, and the second functional member includes a first rotation cooperation structure that rotation-cooperates with the connection member; and
the connection member includes:
a first linkage rod, a first end of the first linkage rod sliding-cooperating with the first sliding being slidingly engaged with the first sliding cooperation structure to cause the first functional member to move along the second direction;
a second linkage rod rotatably connected to the first linkage rod, an end of the second linkage rod rotatably connected to the first rotation cooperation structure, and the other end of the second linkage rod rotatably connected to the main body, which is rotationally connected to the first linkage, wherein one end of the second linkage can be rotationally connected to the first rotational engagement structure, and the other end of the second linkage can be rotationally connected to the main body.

7. The functional assembly according to claim 2, wherein the second functional member includes a first guiding structure, and the main body includes a second guiding structure matching the first guiding structure.

8. The functional member according to claim 2, wherein:
the second functional member includes a locking structure, and the main body includes a first positioning structure and a second positioning structure that cooperate with the locking structure, and the first positioning structure and the second positioning structure have a position difference along the first direction;
in the first state, the locking structure cooperates with the first positioning structure for positioning; and
in the second state, the locking structure cooperates with the second positioning structure for positioning.

9. An electronic device comprising:
a body including a housing; and
a functional assembly arranged in the housing of the first body including:
a main body;
a first functional member movably connected to the main body;
a second functional member moving relative to the first functional member along a first direction and movably connected to the main body; and
a connection member connected to the first functional member and the second functional member to cause the second functional member to switch between a first state and a second state relative to the first functional member.

10. The device according to claim 9, wherein:
the housing includes a first housing and a second housing moving relative to each other and forming a chamber structure configured to accommodate the functional assembly; and
the first functional member of the functional assembly and the first housing move synchronously, and the body is in the second housing.

11. The device according to claim 9, wherein:
the first functional member is movably connected to the main body along a second direction; and
the first direction and the second direction form an angle.

12. The device according to claim 11, wherein:
in the first state, the first functional member and the second functional member are arranged along the first direction, and an orthogonal projection of the first functional member along the first direction at least partially covers the second functional member; and
in the second state, the first functional member and the second functional member are arranged along the second direction, and an orthogonal projection of the first functional member along the second direction at least partially covers the second functional member.

13. The device according to claim 9, wherein:
the first functional member includes a first functional surface, and the second functional member includes a second functional surface; and
when the second functional member switches between the first state and the second state relative to the first functional member, the first functional surface and the second functional surface face a same direction.

14. The device according to claim 9, wherein:
the main body includes an accommodation space; and
in the first state, at least a part of the first functional member is in the accommodation space, and the second functional member is in the accommodation space.

15. The device according to claim 11, wherein:
the first functional member includes a first sliding cooperation structure that sliding-cooperates with the connection member, and the second functional member includes a first rotation cooperation structure that rotation-cooperates with the connection member; and
the connection member includes:
a first linkage rod, a first end of the first linkage rod sliding-cooperating with the first sliding being slidingly engaged with the first sliding cooperation structure to cause the first functional member to move along the second direction; and
a second linkage rod rotatably connected to the first linkage rod, an end of the second linkage rod rotatably connected to the first rotation cooperation structure, and the other end of the second linkage rod rotatably connected to the main body, which is rotationally connected to the first linkage, wherein one end of the second linkage can be rotationally connected to the first rotational engagement structure, and the other end of the second linkage can be rotationally connected to the main body.

16. The device according to claim 11, wherein the second functional member includes a first guiding structure, and the main body includes a second guiding structure matching the first guiding structure.

17. The device according to claim 11, wherein:
the second functional member includes a locking structure, and the main body includes a first positioning structure and a second positioning structure that cooperate with the locking structure, and the first positioning structure and the second positioning structure have a position difference along the first direction;
in the first state, the locking structure cooperates with the first positioning structure for positioning; and
in the second state, the locking structure cooperates with the second positioning structure for positioning.
